(19) United States
(12) Patent Application Publication
(10) Pub. No.: US 2003/0195842 A1
(43) Pub. Date: Oct. 16, 2003

(54) Method and device for making secure transactions

(76) Inventor: Kenneth Reece, Arroyo Grande, CA (US)

Correspondence Address: Mr. Kenneth Reece, 3689 Alisos Road, Arroyo Grande, CA, 93420, US

(21) Appl. No.: 10/413,847

(22) Filed: Apr. 15, 2003

Related U.S. Application Data
(60) Provisional application No. 60/373,070, filed on Apr. 15, 2002.

(51) Int. Cl. G06F 17/60

(52) U.S. Cl. 705/39; 705/41; 705/44

(57) ABSTRACT

A system and device is described, that allows a user to use the existing credit card processing infrastructure to make a secure stored value transaction over a network. A data storage media read/write device is used to deduct stored value from a user's data storage media and optionally transfer said stored value over a network to a financial institution, a service provider or a transaction processor. After the deduction of stored value has been completed a limited-use credit card number is provided to the user for use over a network such as the Internet. The limited-use credit card number is complying with the industry standards for credit card numbers and it has a limited life span and/or a limited spending limit corresponding to the amount of the stored value transaction optionally less a transaction fee. Because the limited-use credit card number is only good for the purchase that it was intended for when the user requested to make a secure payment, the risk of credit card fraud is greatly reduced. The financial institution can optionally allow the limited-use credit card number to be used for more than one purchase over a longer period of time than a few minutes. The present invention, while not limited to electronic commerce transactions using a stored value card, is especially suited for smart card payments over communication networks, without requiring payees to invest in smart card processing infrastructure or signing up for smart card payment processing services.

### CROSS-REFERENCE TO RELATED APPLICATION

This application is entitled to the benefit of Provisional Patent Application Ser. No. 60/373,070 filed Apr. 15, 2002.

### FEDERALLY SPONSORED RESEARCH

Not applicable

### SEQUENCE LISTING OR PROGRAM

Not applicable

### FIELD OF INVENTION

This invention relates in general to transactions made over a network such as the Internet. More specifically it relates to secure transactions made over a network using a stored value.

### BACKGROUND—TERMINOLOGY

Data Storage Media

In the context of the present invention the term data storage medium is used to describe any media that comprises means for storing data.

A plurality of data storage media are known from prior art. A few examples are mentioned below, it being understood that the few examples by no means constitute a complete list of the data storage media that can be used with the present invention:

Bar code card

CD-ROM

Citizen card

Compact Disc

Compact Flash card

Contact smart card

Contact-less smart card

DVD

Floppy disks

Hard disks

IC cards

Loyalty program card

Magnetic stripe card

Memory chip

Memory module

Memory stick

Mini disk

Payment card

PC cards

Phone card

RAM module

SIM cards

Smart Media card

Stored value card

Tapes

Zip disks

Access cards

Election cards

Electronic books

Identification cards

USB dongle

User/Payer

In the context of the present invention a user is a person or other entity that wishes to transfer stored value from a data storage media to another person or entity. The terms user and payer are used interchangeably.

Merchant/Payee/Web merchant

In the context of the present invention a payee is a person or other entity to which a payer whishes to make a payment. Merchants and web merchants are also referred to as payees in the context of the present invention.

Stored Value/Funds

In the context of the present invention stored value is used to describe any electronically stored data that can constitute a “stored value”. A plurality of stored value systems are known from prior art. A few examples are mentioned below, it being understood that the few examples by no means constitute a complete list of the stored value systems that can be used with the present invention:

Electronic cash

Loyalty points

Airline miles

Electronically stored tokens

Electronically stored points

Electronically stored coupons

Prepaid value

Data Storage Media Read/Write Device

In the context of the present invention the term data storage media read/write device is used to describe any device that comprises means of reading data from—and/or writing data to data storage media. Optionally the data storage media read/write device comprises means for coupling said device to a computing device or a network.

For the sake of simplicity the term “card reader” is used in the following to describe a generic data storage media read/write device, it being noted that the data storage media can be any media that comprises means for storing data and that the read/write device can comprise means for both reading data from data storage media and writing data to said media.

A plurality of data storage media read/write devices are known from prior art. A few examples are mentioned below, it being understood that the few examples by no means constitute a complete list of the data storage media read/write devices that can be used with the present invention:

Smart card read/write device (both contact/contact-less and hard wired/wire-less)

Set top boxes

Cell phones

PDA's

Gaming devices

Satellite receivers

Point of Sale terminals

ATM's

Network

In the context of the invention the term “network” is used to describe any network where a plurality of computers, computing devices, game devices, communications devices or other electronic devices are linked together, either through at least one server or through peer-to-peer connections. A few examples of such networks are mentioned below, it being understood that the few examples by no means constitute a complete list of the networks that can be used with the present invention:

Public networks like the Internet

Proprietary networks like AOL and Compuserve

Corporate Intranets

Hotel's internal networks

Telephone networks

Cable networks

The term “network” is used to describe both wired and wireless networks.

Service Provider

In the context of the invention the term “service provider” is used to describe any entity which is providing a service to handle transactions as described in the present invention. Such a service provider might typically be a bank or a payment processor. A service provider in the context of the present invention can also conceivably be a merchant or a web merchant, or any other entity providing transaction services.

### BACKGROUND—INTRODUCTION TO THE SMART CARD INDUSTRY

Description of Smart Cards

The microcircuit of a smart card is usually based on a microprocessor or a micro-controller including memory circuits, for example of the “PROM” or “EPROM” type. Data can be stored in the aforementioned memory circuits, usually in encrypted form. Some common uses of smart cards include storing value, storing information for use for identification purposes, or for access control. The data is read from memory locations and/or written to memory locations.

Other logical architectures are used in particular for “electronic purse” or similar type applications.

To read information from a card or write information to a card, a device must be provided wherein a card can be inserted for reading and/or writing data to and from the card. For the sake of simplicity, such a device will be referred to as a “reader” or a smart card reader, it being understood that it can equally write data and perform other ancillary functions (such as electrical power supply, presence tests etc.) referred to hereinafter and in the prior art.

In all cases a smart card incorporates at least one electronic component which comprises input/output members to which a link must be established, either through an electrical connection (in the case of a contact smart cards) or through a wireless connection (in the case of a contact-less smart cards). Said input-output members are often provided in the form of contact areas, also known as “pads”, flush with the surface of one of the principal faces of the card. Various standards (ISO, AFNOR, etc.) define the position and lay out of these contact areas. They are used not only for the aforementioned data inputs-outputs but also to supply electrical power to the microcircuit and to enable various checks to be carried out, according to the applications concerned (presence test, etc.). Contact smart cards traditionally are formed of a plastic plate having about the same thickness as a credit card, with an integrated circuit imbedded in the plastic and with contact pads on a surface of the card. Such cards come in different sizes, with the large size commonly being about the size of a credit card and with a popular small size being referred to as a MICROSIM or simply SIM card. The prior art has provided a plurality of other forms of smart cards, for example where a microchip is embedded in a key or a device to place on a wrist for access control. Often these devices are referred to as tokens. For the sake of simplicity these tokens are also referred to as cards in the context of the present invention. The form or shape of the smart card is not important to this invention as it can be adapted to be used with any type of Integrated Circuit card, no matter what form or shape.

Description of Link Between Card and a Computing Device

The contact smart cards are inserted into connectors that make contact between the contact pads of the card and a plurality of contacts comprised in the connector to establish an electrical connection to the electronic components of a circuit board (such as a PCB).

The contact-less smart cards uses wireless means of communication, such as Radio Frequencies, to couple the smart card and the electronic components of a PCB. A conductive path is provided on a PCB to form an integral antenna, which is used to communicate with the smart card.

Smart Cards in Use

Smart cards are particularly adapted for use in industries requiring strict access or billing control and convenient as well as secure access to sources of payments and information. Such applications include public phones, vending machines, copy machines, laundry machines, public transportation ticketing and portable devices such as cellular phones, pagers, PDA's, laptop computers and other similar electronic devices and also stationary devices such as a PC, a satellite receiver or a telephone. Such cards can also be used in applications relating to payments, identification, loyalty programs, citizen cards, electronic elections, health services, ticketing, security access, software copy-protection, building access and machine controls etc.

The cards are commonly used to authorize transactions such as purchases of goods, for access control, for identification purposes, and to allow operation of an automobile radio or a lock. Use of smart cards for secure identity authentication purposes and for online payment transactions over the Internet are expected to increase in the next few years.

Today there are many hundred million smart cards in use around the world. Although many uses have been proposed and developed, today smart cards are mainly used as prepaid phone cards, as Satellite TV cards or as SIM cards in cellular phones.

In recent years banks and financial institutions have begun to issue smart card credit cards, in order to prepare for the future, merchants have begun to issue smart cards as loyalty cards, government agencies are using smart cards to control access to buildings, transit authorities are using smart cards to store tickets and cities are using them for parking purposes.

Introduction of the Object of a Smart Card Reader

In order to effect electrical connection between a contact smart card and the electronic components of a PCB, an electrical connector or smart card reader is employed such that the connector securely accommodates the smart card therein. The connector serves as an interface between a smart card and a reading system that interprets the information contained in the card. A few examples of such reading systems are computers, satellite receivers, cell phones, pay phones, electronic locks etc.

In order for a user to take full advantage of the possibilities that smart cards offer, in particular to use a smart card over a network connection (such as the Internet), a card reader must be coupled to the user's computing device. The card reader establishes a link between the information comprised in a microchip on the smart card and a computing device such as a PC.

The participants in the smart card industry such as smart card manufacturers, system providers and card issuers such as banks or credit card companies and different card based loyalty programs, are all facing the same common problem that there is no infrastructure in place, to facilitate the widespread use of smart cards. Once a critical mass of consumers have card readers installed, a number of services such as E-banking are likely to occur.

As smart cards and card readers become more commonplace, smart card holders find themselves equipped with a card comprising an advanced technology that allows a user to make a “cash” transaction over a network such as the Internet, by transferring a stored value from the card over the network to a receiver such as an internet merchant. This is very much in the interest of consumers because using a smart card to make Internet payments greatly reduces the risk of credit card fraud and identity theft. Because no account—or credit card information is provided to a merchant when using a smart card to make a payment, there is no risk that the card holder's credit card number will later be abused by the merchant or anyone else.

The Smart Card Industry'S Problem

Today it is technically possible to make a transaction over a network such as the Internet by transferring an electronically stored value from one point to another. Today smart cards are the preferred solution for storing said “stored value”, but a plurality of other data storage media can also be used for this purpose. In practice a user cannot make a smart card transaction over the I Internet because no online merchants are accepting smart cards as a payment form. The reason is that very few cardholders are equipped with card readers, so web merchants and payment processors have not yet established the systems to deduct a stored value from a user's card and transfer it to the merchant.

Because only a very limited number of cardholder's have the capability to use their smart card over the Internet, there are almost no possibilities being provided of using a smart card over the Internet. When there is nothing—or very little a card holder can use her smart card for over the Internet, it is not likely that she will invest the time and money to acquire a smart card reader and connect it to her PC. This paradox is one of the main problems that are facing the smart card industry and the card issuers.

Once merchants begin accepting smart card payments over a network (such as the Internet), it will still require that every merchant invest in payment processing technology, or sign up with a payment processor. This means that even when some merchants begin to accept smart cards as a payment form over a network, a consumer might still often find websites that will not accept smart cards as payment, thus forcing the user to use a regular credit card (with increased risk of fraud) or search for another merchant that have the same goods or services.

### DEMANDS

From the above description, a number of demands become evident:

Demand for a Secure Online Payments

There is a demand for consumers to be able to conduct secure online payments, without the high fraud risk associated with traditional credit cards. This is not only a consumer concern but also a major concern of merchants and banks who in many cases must cover the loses related to credit card fraud.

Demand for Private Online Payments (to Avoid Spam and Telemarketing Sellers)

There is a demand for a consumer to be able to make a payment, without revealing personal information such as address or email address. There are numerous reports that describe how personal information have been sold to third parties, many times resulting in unwanted junk mail and junk email.

Demand for Consumers to Make Secure Smart Card Transactions Over a Network

There is a demand for a solution that allows users to be able to use secure transactions over a network.

Demand For Providing A Solution That Does Not Require Merchants To Sign Up

There is a demand for a solution that can allow a user to use a smart card to make a payment over the internet, even if the receiver (such as an online merchant) is not providing the option of paying with smart cards.

Demand for Making Micro-Payments

There is a demand for a solution that make it viable for a user to make a Micro-payment over a network.

### OBJECTS AND ADVANTAGES

Objects

It is an object to provide a secure network payment solution that significantly reduces the risk of credit card fraud compared to the use of regular magnetic stripe credit cards.

It is an object to enable a user to make a purchase over a network, without providing any irrelevant personal information about the user to the merchant.

It is an object to provide a solution that allows users to make smart card transactions over a network.

It is an object to provide a solution that allows a user to make a smart card payment, event to online merchants that does not provide smart cards as a payment option.

It is an object to provide a solution that will allow a user to make a Micro Payment over the network.

Advantages

This system has several advantages:

1) It allows a user to make a smart card payment, even if the payee is not capable of accepting smart cards.

2) There is no requirements for online merchants, governments and organizations to invest in smart card enabled infrastructure, or to sign up for new payment services.

3) The system allows a user to make a payment, without revealing credit card information thus greatly reducing the risk of fraud.

4) User's that do not have a credit card can still use the system to make online credit card payments.

5) The system allows card issuers to rely on the existing payment processing infrastructure to facilitate stored value transactions.

### SUMMARY

A device and a system is described, that allows a user to make a secure transaction over a network, to make a payment using stored value without any requirement for the payee to be able to accept said stored value as a method of payment. The preferred embodiment of the invention utilizes smart cards as the media on which said stored value is stored but also other data storage media can be used.

When checking out from an E-commerce website that accepts any means of online payment, a user can opt to have the payment amount plus optional fees deducted from a stored value on a smart card which can optionally be coupled to a network through a card reading device. The stored value is deducted from the user's smart card by a third party such as a payment processing service provider (PPSP). When the PPSP has concluded the transaction and received an amount from the user's card, the user is in turn provided with a limited-use credit card number (and/or other necessary account information) for use in the transaction between the user and the online merchant. The limited-use credit card number can be one of a plurality of numbers that are pre-assigned to the user's account or smart card, or it can be generated from time to time using an algorithm. When the service provider receives the stored value from the user's card, a limited-use credit card number is provided with limited lifespan and spending limits. Because the credit card number is only good for the purchase that it was intended for when the user requested to have an amount deducted from a smart card, the risk of the user getting defrauded in connection with the transaction is eliminated. The service provider can optionally allow that the limited-use credit card number can be used for more than one purchase over a longer period of time than a few minutes.

### INTRODUCTION OF PRIOR ART

The art has utilized a number of limited use credit card number systems as well as anonymous credit card systems.

US Patent Application US 2001/0047335 A1 discloses a secure transaction method and system to allow for goods or services to be paid for using a limited use credit card number. A limited use credit card number is generated by a customer using a number generating device. The system has the drawback that it relies on the user having a credit account and it does not allow a customer to use a stored value card to make a payment.

See the following US Patents, each of which is incorporated herein by reference:

| Inventor | U.S. Pat. No. |
|---|---|
| Moreno | 4007355 |
| Anderson et al. | 4186871 |
| Nagata | 4197986 |
| Ugon | 4211919 |
| Fak et al. | 4214230 |
| Giraud | 4215421 |
| Haruki | 4219151 |
| Konheim et al | 4223403 |
| Atalla | 4268715 |
| Giraud | 4271482 |
| Stuckert | 4277837 |
| Atalla | 4283599 |
| Bouricius et al. | 4302810 |
| Atalla | 4304990 |
| Benton | 4305059 |
| Merkle | 4309569 |
| Sendrow | 4317957 |
| Powell | 4320387 |
| Bouricius et al. | 4326098 |
| Benton | 4341951 |
| Atalla | 4357529 |
| Smid et al. | 4386233 |
| Chesarek | 4386266 |
| Campbell | 4408203 |
| Zeidler | 4423287 |
| Mueller-Schloer | 4438824 |
| de Pommery et al. | 4450535 |
| Benton | 4454414 |
| Mollier | 4467139 |
| Herve | 4471216 |
| Decavele et al. | 4498000 |
| Chaum | 4529870 |
| Atalla et al. | 4536647 |
| Ugon | 4544833 |
| Saada et al. | 4549075 |
| Ugon | 4556958 |
| Nagata et al. | 4594663 |
| Robert et al. | 4612413 |
| Benton et al. | 4625276 |
| Pugsley et al. | 4629874 |
| White | 4630201 |
| Herve | 4638120 |
| Hale et al. | 4652698 |
| Mollier et al. | 4656474 |
| Matyas | 4661658 |
| Hirokawa | 4672182 |
| Davies | 4679236 |
| Wirstrom et al. | 4691355 |
| Kashkashian, Jr. | 4700055 |
| Watanabe | 4709136 |
| Yashida | 4709137 |
| Aaro et al. | 4720859 |
| Munck et al. | 4723284 |
| Oncken et al. | 4725719 |
| Yoshida | 4736094 |
| Daughters et al.. | 4742215 |
| Kruse et al. | 4786790 |
| Wright et al. | 4802218 |
| Igasawara. | 4831245 |
| Nakano. | 4839504 |
| Mori | 4877947 |
| Halpern | 4877950 |
| Wright et al. | 4900903 |
| Halpern | 4906828 |
| Benton et al. | 4926325 |
| Bestock et al. | 4933971 |
| Austin | 4935962 |
| Gorog | 4947028 |
| Collin | 4992646 |
| Yoshida | 5012076 |
| Collin | 5030806 |
| Donald et al. | 5053956 |
| Scwartz. | 5093862 |
| Mansvelt et al. | 5175416 |
| Iijima | 5225664 |
| Takagi et al. | 5227613 |
| Graves | 5239166 |
| Pailles et al. | 5247578 |
| Rossides | 5269521 |
| Chaum | 5276736 |
| Kuriyama | 5285200 |
| Iijima | 5293029 |
| Holtey et al. | 5293424 |
| Beller et al. | 5299263 |
| Vizcaino | 5317636 |
| Atalla et al. | 5319710 |
| Avarne | 5323465 |
| Lundstrom et al.. | 5332889 |
| Axelrod et al. | 5337358 |
| Barney et al. | 5341426 |
| Goldfine et al. | 5343529 |
| Molva et al. | 5347580 |
| Ohno | 5355413 |
| Gutowitz | 5365589 |
| Bocinsky, Jr. | 5371797 |
| Haber et al. | 5373561 |
| Scheidt et al. | 5375169 |
| Lundstrom et al.. | 5378884 |
| Larsson et al. | 5379344 |
| Ishiguro et al. | 5396558 |
| Yashida | 5401950 |
| Mihm, Jr. | 5402490 |
| Nevoux et al. | 5412726 |
| Aziz | 5416842 |
| Low et al. | 5420926 |
| Fischer | 5422953 |
| Akiyama et al. | 5428684 |
| Storck et al.. | 5434395 |
| Chaum | 5434919 |
| Augustine et al. | 5440633 |
| Bellovin et al. | 5440635 |
| Ishiguro et al. | 5446796 |
| Brown et al. | 5455863 |
| Claus | 5461217 |
| Eberhard | 5473689 |
| Kaufman et al. | 5475763 |
| Owens et al. | 5481611 |
| Denno et al. | 5493613 |
| Kaufman et al. | 5497421 |
| Ishiguro et al. | 5502765 |
| Clark | 5517569 |
| Augustine et al. | 5524052 |
| Taylor. | 5530232 |
| Davis et al. | 5544086 |
| Liang et al. | 5548106 |
| Hogan | 5557516 |
| Davis et al. | 5559887 |
| Taylor | 5578808 |
| Mark. | 5583933 |
| Pitroda | 5590038 |
| Davis, et al. | 5596642 |
| Campana et al. | 5602915 |
| Mueller | 5602917 |
| Dolan et al. | 5604801 |
| Aziz | 5604803 |
| Micali | 5604804 |
| Davis et al. | 5633930 |
| Newman et al. | 5665951 |
| Brands | 5668878 |
| Aditham et al. | 5706349 |
| Anderson et al. | 5706442 |
| Chelliah et al. | 5710887 |
| Everett et al. | 5715431 |
| Deo et al. | 5721781 |
| Drerup | 5740364 |
| Dillaway et al. | 5742756 |
| Wagner | 5742845 |
| Rosen | 5745886 |
| Nishioka et al. | 5754656 |
| Rosen | 5774553 |
| Watanabe, et al. | 5774884 |
| Jones et al. | 5778067 |
| Caputo | 5778071 |
| Fox et al. | 5790677 |
| Paradinas, et al. | 5796831 |
| Rosen | 5799087 |
| Tago | 5864829 |
| Pitroda | 5884271 |
| Ginter et al. | 5892900 |
| Chew | 5901303 |
| Rosen | 5920629 |
| Corder, et al. | 5936221 |
| Rosen | 5953423 |
| Rosen | 5963648 |
| Williams et al. | 5963924 |
| Kumomura | 5963926 |
| Rosen | 5978485 |
| Turk, et al. | 5983207 |
| Nakano, et al. | 5987438 |
| Wissenburgh, et al. | 5991412 |
| Rowney et al. | 5996076 |
| Kawan | 6012049 |
| Brennan | 6014648 |
| Williams et al. | 6016484 |
| Demers, et al. | 6021399 |
| Bombard, et al. | 6023508 |
| Molano et al. | 6032135 |
| Barlow, et al. | 6038551 |
| Fleischl, et al. | 6038552 |
| Rosen | 6047067 |
| Biffar | 6047269 |
| Thomas | 6064988 |
| Teicher | 6065675 |
| Teicher | 6076075 |
| Schenkler | 6078902 |
| Davis, et al. | 6105008 |
| Davis et al. | 6105008 |
| Morrison, Jr. | 6105011 |
| Weiss, et al. | 6131810 |
| Jonstromer | 6142369 |
| Lee-Wai-Yin | 6167387 |
| Moran, et al. | 6185542 |
| Husemann, et al. | 6192349 |
| Heinzle, et al. | 6199046 |
| Biffar | 6205435 |
| Rosen | 6205436 |
| Mori, et al. | 6223169 |
| Chan et al | 6233683 |
| Keathley et al. | 6247129 |
| Shiobara, et al. | 6266653 |
| Davis et al. | 6282522 |
| Nagata, et al. | RE32,985 |
| Takahashi | Re33571 |
| Mansvelt et al. | Re36788 |

Other References

1. Alfred R. Berkeley,III, “Nasdaq's Technology Floor: Its President Takes Stock”, IEEE Spectrum 1997.

2. Applications in the banking and financial sector, Ch. 6, pp. 73-81, no date.

3. Ascom Autelca AG, “Opposition (3)”, Sep. 26, 1995, EPO.

4. Baldwin, et al., “Locking the E-Safe”, IEEE Spectrum February 1997.

5. Bank Cards—Magnetic Strip Data Content For Track 3, 1987, International Standard, ISO 4909 Second Edition.

6. Beutelspacher, et al. Payment Applications with Multifunctional Smart Cards, 1989, Smart Card 2000.

7. Brian Santo, “Bill-paying put on line”, Mar. 20, 1995, Electronic Engineering Times.

8. Cabinet Hirsch, Appeal of European Patent EP 0 421 808, Oct. 19, 1998, European Patent Office.

9. Carol H. Fancher, “Smart Cards as Potetial Applications Grow, Computers in the Wallet are Making Unobstrusive Inroads”, August 1996, Scientific American Website.

10. Carol Hovenga Fancher, “In Your Pocket Smartcards”, IEEE Spectrum Feb. 1997.

11. Cash .TM. Secure Internet Payment Service .TM. “CyberCash's Secure Internet Payment Services”, CyberCash, Inc., Reston, Va. 22091.

12. Cash.TM. Secure Internet Payment Service.TM. “CyberCash's Secure Internet Payment Services”, CyberCash, Inc., Reston, Va. 22091.

13. Chaum et al., “SmartCard 2000: The Future of IC Cards”, Oct. 19, 1987, Elsevier Science Publishers, B. V.

14. Chip Card News Intamic, December 1988, No. 26., including 3 articles.

15. Chip Card News, Aprril 1983, No. 5.

16. David Chaum, et al., “Minting Electronic cash”, IEEE Spectrum Feb.1997.

17. David Chaum, Provacy Protected Payments Unconditional Payer and/or Payee Untraceability, 1989, Smart Card 2000.

18. David Naccache, “Cryptographic Smart Cards”, Jun. 3, 1996, IEEE Micro 1966 Website.

19. Deutsche Telekom AG; “Opposition (2)”, Sep. 26, 1995, EPO.

20. Edward W. Kelley, Jr., “The Future of Electronic Money: A Regulator's Perspective”, IEEE Spectrum, February 1997.

21. Elkington and Fife, “Patentee's Statement”, Feb. 19, 1998, EPO.

22. Elkington and Fife, “Response to the Communications of Notices of Opposition dated Mar. 1, 1996”, Sep. 13, 1996, EPO.

23. EPO Opposition Division, “Annex to Summons”, Oct. 16, 1997.

24. EPO Opposition Division, “Minutes of Oral Proceedings”, Jun. 15, 1998, EPO. 25. EPO Opposition Division, Annex to Summons, Reference No. RAL/014/F6658, Application No. 90310934.6-2207/0421808, Mansvelt, Andre Peter, et al., Oct. 16, 1997.

26. EPO Opposition Division, Interlocutory Decision in Opposition Proceedings, Jun. 15, 1998, EPO.

27. EPO, PCT International Search Report, PCT/US 98/08806, Aug. 24, 1998, (4 pages). 28. Financial Information Systems, Report from the Financial Committee of the IC Card Study Group, “Usage and Standardisation of IC Cards in Finance”, Financial Information Systems Centre (FISC) Foundation, No. 18, 1986.

29. Financial transaction Cards-Security Architecture of Financial Transaction System Using Integrated Circuit Cards—Part 1: Card Life Cycle, Sep. 15, 1991, International Standard, ISO 1020-1, First Edition.

30. Gemplus: A Brief History, Gemplus SA; Gemenos, France;http://www.gemphus.com/company-overview,html, No Date.

31. Giesecke & Devrient GmbH, “Opposition (4)”, EPO.

32. Hawkes et al., “Integrated Circuit Cards, Tags and Tokens”, 1990, BSP Professional Books. 33. Herbert F. W. Schramm, “POS-Banking mit Chipkarten,” 1987, Geldinstitute No. 1, pp. 70-71. (English translation included).

34. Hiro Shogase, The Very Smart Card: A Plastic Packet Bank:, October 1988, IEEE Spectrum.

35. Howard Anderson, “Money and the Internet: A Strange New Relationship” IEEE Spectrum 1997.

36. Identification Card System—Inter-Sector Electronic Purse Part 3: Data Elements and Interchanges, 1994, European Prestandard, prEN 1546-3.

37. Identification Card System—Inter-Sector Electronic Purse Part 4: Devices, 1994, European Prestandard, prEN 1546-4.

38. Identification Card Systems—Inter-Sector Electronic Purse Part 1: Concepts and Structures, 1994, European Standard, PrEN 1546.

39. Identification Card Systems—Intr-Sector Electronic Purse Part 2: Security Architecture, 1994, European Standard, prEN XXXXX-2.

40. Identification Cards—Contactless Integrated Circuit(s) Cards—Part 1: Physical Characteristics, 1992, International Standard, ISO/IEC 10536-1, First Edition.

41. Identification Cards—Contactless Integrated Circuit(s) Cards—Part 2: Dimensions and Location of Coupling Aresa, 1995, International Standard, ISO/IEC 10536-2, First Ed.

42. Identification Cards—Contactless Integrated Circuit(s) Cards—Part 3: Electronic Signals and Reset Procedures, 1996, International Standard, ISO/IEC 10536-3, First Edition.

43. Identification Cards—Financial Transaction Cards Amendment 1 1996, International Standard, ISO/IEC 7813, Fourth Eiditon.

44. Identification Cards—Financial Transaction Cards, 1990, International Standard, ISO/IEC 7813, Third Edition.

45. Identification Cards—Integrated Circuit(s) Cards With Contacts Part 1: Physical Characteristics, 1987, International 46. Standard, ISO 7816-1, First Edition.

47. Identification Cards—integrated Circuit(s) Cards With Contacts Part 2: Dimensions and Location of the Contacts, 1988, International Standard ISO 7816-2, First Edition.

48. Identification Cards—integrated Circuit(s) Cards With Contacts Part 3: Electronic Signals and Transmission Protocols, International Standard, ISO/IEC 7816-3, First Edition.

49. Identification Cards—integrated Circuit(s) Cards with Contacts Part 4: Inter-Industry Commands for Interchange, International Standard, ISO/IEC 7816-4, First Edition.

50. Identification Cards—Integrated Circuit(s) Cards With Contacts Part 5: Numbering System and Registration Procedure for Application Identifiers, 1993, International Standard, ISO/IEC DIS 7816-5.

51. Identification Cards—Physical Characteristics, 1995, International Standard, ISO/IEC 7810, Second Edition.

52. Identification Cards—Recording Technique—Part 1: Embossing, 1995. International Standard, ISO/IEC 7811-1, Second Edition.

53. Identification Cards—Recording Technique—Part 2: Magnetic Strip, 1995, International Standard, ISO/IEC 7811-2, Second Edition.

54. Identification Cards—Recording Technique—Part 3: Location of Embossed Characters on ID-1 Cards, 1995, International Standard, ISO.IEC 7811-5, Second Edition.

55. Identification Cards—Recording Technique—Part 4: Location of Read-Only Magnetic Tracks—tracks 1 & 2, 1995 International Standard, ISO/IEC 7811-4, Second Edition.

56. Identification Cards—Recording Technique—Part 5: Location of Read-Write Magnetic Track—Trck 3, 21995, International Standard ISO.IEC 7811-5, Second Edition.

57. Identification Cards—Recording Technique—Part 6: Magnetic Stripe-High Coercivity, 1996, International Standard, ISO/IEC 7811-6, First Edition.

58. International Cards—Integrated Circuit(s) Cards With Contacts Part 6: Inter-Industry Data Elements, 1995, International Standard, ISO/IEC DIS 7816-6.

59. Jerome Svigals, “Smart Cards, The New Bank Cards,” 1987, MacMillan Publishing Company, New York, Revised Edition, Chapter 2 “Smart Cards for Financial Transactions,” p. 60.

60. Jerome Svigals, “SmartCards The New Bank Cards”, 1985, MacMillan Publishing Company.

61. Jerome Svigals, “SmartCards The Ultimate Personal Computer”, 1985, MacMillan Publishing Company.

62. Klunker Schmitt-Nilson Hirsch, “Appeal of European Patent EP 0 421 808”, Oct. 19, 1998, European Patent Office.

63. Koninklijke PTT Nederland N. V., “Opposition (6)”, EPO.

64. La Carte A Micro-Calculateur Multi-Applications MP-ADF, Bull CP8: TD 0143F.01, August 1988. (English translation included).

65. Leslie Marable, “A Test Moves Net-Based Bill Payment a Step Closer”, WebWeek, The Newspaper of Web Technology and Business Strategy, vol. Three, Issue Three, Feb. 3, 1997.

66. Lynch et al., “Digital Money, The New Era of Internet Commerce”, Copyright .COPYRGT. 1996, John Wiley & Sons, Inc.

67. Marvin A. Sirbu, “Electronic Payments—Credits and Debits on the Internet”, Carnegie Mellon University, IEEE Spectrum Feb. 1997.

68. Michael C. McChesney, “Banking in Cyberspace: An Investment in Itself”, IEEE Spectrum 1997.

69. Michael Waidner, Birgit Pfitzmann, “Loss-Tolerant Electronic Wallet”, 1991, Elsevier Science Publishers B. V.

70. Mike Ter Maat, “The Economics of E-Cash”, IEEE Spectrum 1997.

71. Notice of Appeal; Ref. PJF/CB/0665800P; date: Jul. 13, 1998; author: none; Publisher: European Patent Office.

72. P. Remery et al., “Le paiement electronique”, 4, trimestre, 1988.

73. Peter S. Gemmell, “Traceable E-Cash”, Sandia National laboratories, IEEE Spectrum Feb. 1997.

74. Preussag AG, “Opposition (1)”, Sep. 27, 1995, EPO.

75. Prof. Shimon Even, “Secure Off-line Electronic Fund Transfer Between Nontrusting Parties”, Smart Card 2000, 1989.

76. References to: INTERNET STORED VALUE CARD TRANSACTION SYSTEM

77. Roy Bright, “Smart Cards: Principles, Practice, Application,” 1988, Ellis Horwood Limited, pp. 73-81, Ch. 6.

78. S. Even et al., “Electronic Wallet,” June 1983. 79. Santo, Brian; “The NetBill Electronic Commerce Project”, Mar. 20, 1995: pp 1-14 Electronic Engineering Times.*

80. Schlumberger Industries SA, “Opposition (5)”, EPO.

81. Siemens Short Form Catalog: Integrated Circuit Division 1995/1996; http://www.allianet.com/siemens/catalog/08.html.

82. Stanley E. Morris, “Crime and Prevention: A Treasury Viewpoint”, IEEE Spectrum Feb. 1997.

83. Steven Levy, “E-Money (That's What I Want)”, December 1994, Wired Magazine.

84. Steven M. H. Wallman, “Technology Takes to Securities Trading”, IEEE Spectrum 1997.

85. Tekla S. Perry, “Electronic Money: Toward a Virtual Wallet”, IEEE Spectrum, Feb. 1997.

86. The Smart Card Cyber Show, Analyses Et Synthesis; Paris, France; No Date; http://www.cardshow.com/industry/CP8Transac.

87. To Probe Further, Special Issue, IEEE Spectrum 1997.

88. von W. Ott et al., “Kartenanwendungen im Fernmeldewesen,” Der Fernmelde-lngenieur, August/September 1989, pp. 64-70. (English translation included).

89. Waidner, et al., Loss-Tolerant Electronic Wallet, 1991, Smart Card 2000.

90. Yrjonen et al., Chip Cards—Bank Notes of the Future, Paper to be presented at ESCAT 1988, Sep. 5-7, Helsinki, Finland.

91. Zoreda et al., “Smart Cards”, 1994, Artech House.

### DRAWINGS

Figures

FIG. 1 is a schematic illustration of a payment system according to the preferred embodiment of the invention.

FIG. 2 is a schematic illustration of a payment system according to an alternate embodiment of the invention.

FIG. 3 is a simplified block diagram illustrating a payment process according to one embodiment of the invention.

FIG. 4 is a schematic diagram that illustrates one embodiment of a system according to the present invention that comprises a data storage media read/write device of the present invention data storage media.

FIG. 5 is a simplified block diagram illustrating of a payment system according to an alternate embodiment of the invention.

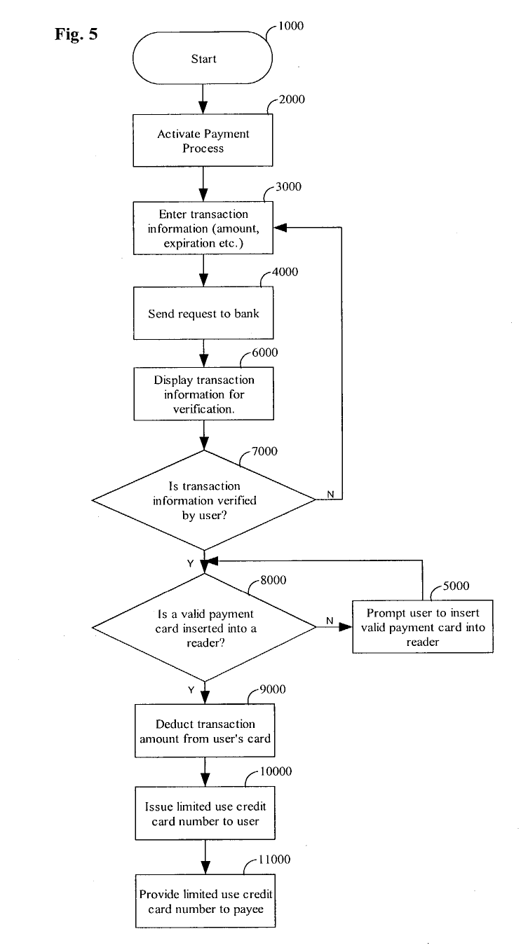

FIG. 6 is a simplified block diagram illustrating of a payment system according to an alternate embodiment of the invention.

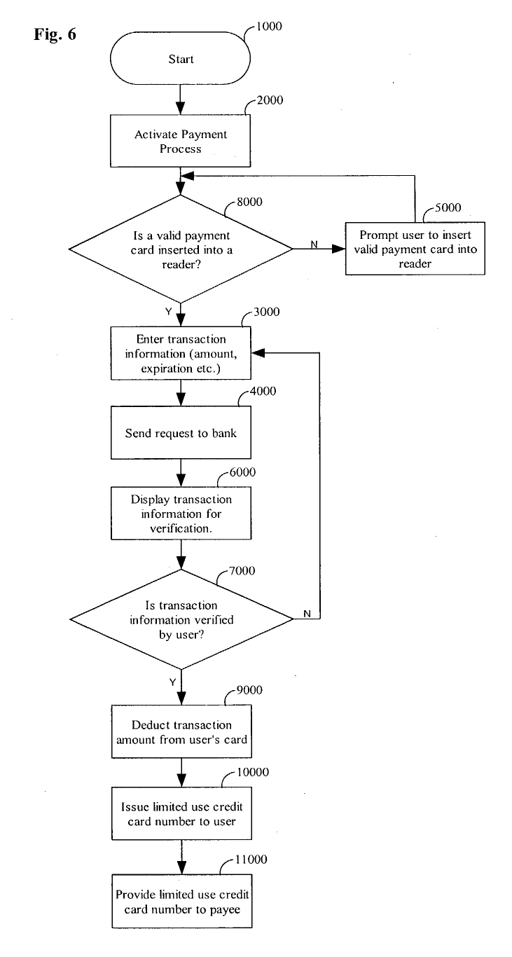

### REFERENCE NUMERALS

100 Payer

200 Data storage media in the form of a payment card

210 Optional communication unit of 200

220 Optional security unit of 200

222 Optional decryption unit of 200

224 Optional encryption unit of 200

230 Optional ID unit of 200

232 Optional card issuer data unit of 200

234 Optional cardholder data unit of 200

236 Optional card data unit of 200

240 Optional programming unit of 200

250 Optional application unit of 200

252 Example application 1 of 200

254 Example application 2 of 200

300 Data storage read/write device in the form of a card read/write device

310 Optional communication unit of 300

320 Optional security unit of 300

322 Optional decryption unit of 300

324 Optional encryption unit of 300

330 Optional data unit of 300

331 Optional authorization database of 300

332 Optional limited-use credit card number database of 300

340 Optional programming unit of 300

350 Optional application unit of 300

360 Optional ID unit of 300

362 Optional card reader data unit of 300

364 Optional card reader provider data unit of 300

400 Payer's computing device

500 Network

600 Bank/service provider/payment processor

700 Payee

1000 Start of payment process

2000 Process activation

3000 Entering transaction information

4000 Card validation

5000 Prompting user

6000 Transaction request

7000 Display transaction verification

8000 Transaction verification

9000 Value transfer

10000 Limited credit card number issuance

11000 End payment process

### DETAILED DESCRIPTION OF DRAWINGS

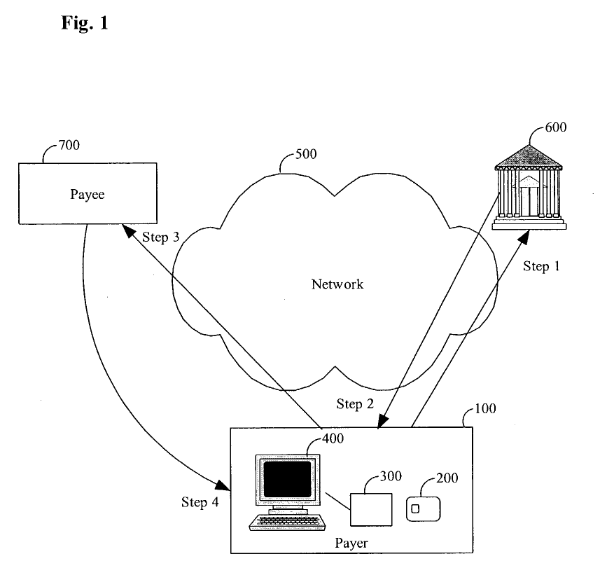

FIG. 1 is a schematic illustration of a payment system according to the preferred embodiment of the invention.

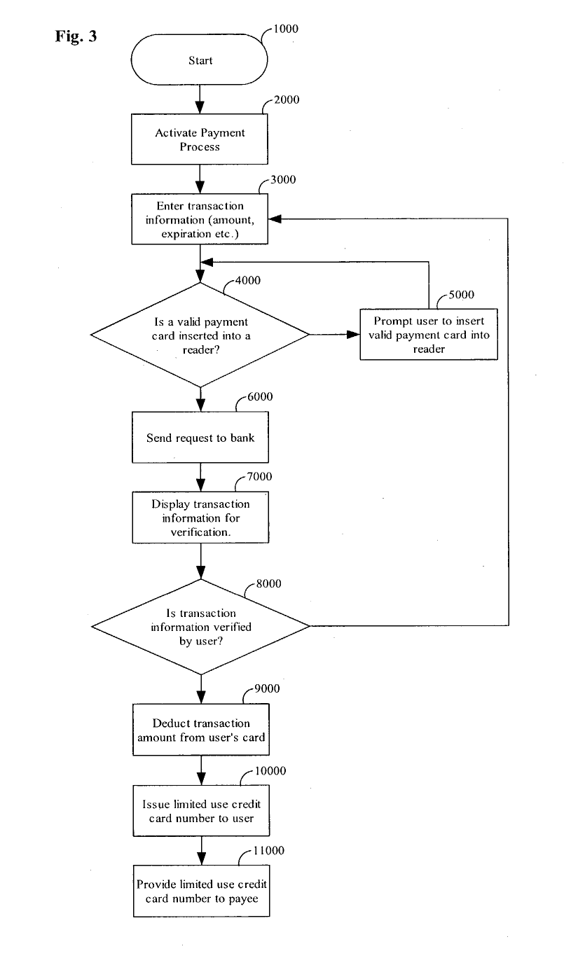

When a user (100) whishes to make a secure payment over a network such as the Internet (500), a stored value card (200) is inserted into a card read/write device (300) which is coupled to said network, optionally through a computer (400). A connection is made to a payment processor such as a bank (600) and information about the desired transaction—such as the amount—is provided to the payment processor. After verification of the transaction information and validation of the inserted stored value card, the agreed amount and optionally a transaction fee and(or other fees are deducted from the stored value card and transferred over a network to the payment processor or an acquirer (step 1). The user (100) is in turn provided with a limited use credit card number (step 2), with an expense limit corresponding to the amount that was deducted from the user's stored value card (optionally less transaction fees) and optionally a limited lifespan, such as an hour or a day. The user then completes the transaction by providing said limited use credit card number to the payee (700) (step 3) after which the goods or services can be provided to the user (step 4). Any payment system of the prior art using limited-use or anonymous credit card numbers and/or limited-use or anonymous account numbers can optionally be used as part of the present invention to provide a limited-use credit card—or account number to the user as step 10000 of FIG. 3 or alternate embodiments of the invention. One example of such prior art is US Patent application 2001/0047335 A1 (in the following referred to as “335 A1”), Arndt et al. In “335 A1” a limited-use credit card number is generated by a user using a number generating device. Used with the present invention the number generating device of “335 A1” would be used in step 10000 of FIG. 3 to provide a limited use credit card number to the user with a spending limit corresponding to the transferred from a stored value card in step 9000. A plurality of examples of payment systems of the prior art that can be used with the present invention is disclosed above under “Description of prior art” all of which are comprised herein in its entirety by reference.

Operation of the Preferred Embodiment

FIG. 3 is a simplified block diagram illustrating a payment process according to the preferred embodiment of the invention.

In step 1000 a user locates goods or service over a network such as the Internet. When the user is ready to make a secure payment, the payment process is activated by said user (step 2000). Said payment process can be activated in a plurality of ways, such as by a mouse click on an icon on a computer desktop, the push of a button on a payment device, the use of a remote control, by entering a specific website etc. In the preferred embodiment of the invention, the user activates the payment process by clicking on an icon on a computer screen. After the payment process has been activated, the user is prompted to enter information regarding the desired transaction (3000). In the preferred embodiment the user is only asked to provide the desired amount for the transaction. In other embodiments of the invention the user can be required to provide other—or additional information, and the smart card can optionally be protected by a PIN code or a password. In step 4000 a validation of the inserted smart card is performed to control that the inserted card is of an authorized type, that the card contains sufficient funds to make the transaction, that the card has not expired or been reported stolen etc. If the card is not valid an error message is displayed to the user (4500) and the user is prompted to insert a valid card (5000).

Other embodiments of the present invention utilize software programs, to automate some or all of the payment process. One example is a web browser plug in—or an actual web browser application, which automatically detects, when a user is on a web merchant's check out page, if desired prompts the user to activate the payment process, deducts the stored value from the user's card, receives the limited use credit card number from the service provider—or receives a released stored limited use credit card number from a card or a reader, and automatically passes on the limited use credit card number to the web merchant. The individual card issuers and service providers decide which levels of security and user verifications are needed in the above described automatic process.

In step 6000 a request is send to a payment processor or a payment service provider (for the sake of simplicity the payment processor is referred to as the bank in the following). Said request can be send to the bank in a plurality of ways. In the preferred embodiment the request to make a secure payment is send to the bank via the Internet. When the bank receives the request to make a secure payment, a message is displayed asking the user to verify the transaction information (step 7000). I the user does not verify the transaction information in step 8000, the process is interrupted, and the user is referred to step 3000. If the user in step 8000 confirms that the transaction information is correct, the agreed amount is deducted from the user's card and transferred to the payment processor (step 9000). In alternate embodiments of the invention, the deducted value is not transferred to the payment processor, but simply erased from the user's card or put in a separate holding area of the account for later collection.

When the payment processor has received the payment, a limited use credit card number is issued and provided to the user (step 10000). The user in turn provides said limited credit card number to the payee (step 11000).

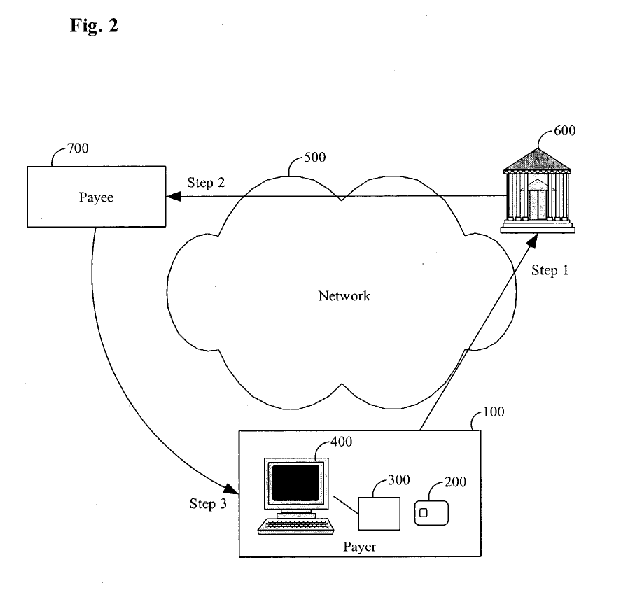

FIG. 2 is an alternate embodiment of FIG. 1. Part of the transaction information that is send to the service provider (600) in step 1, is information regarding the payee's website such as an URL and information about the current session. After the service processor (600) has received payment from the payer (100) the limited use credit card number is directed to the payee, using the information that was submitted to the service provider in step 1. The payee can optionally allow service providers to automatically fill out the required information such as credit card number and expiration date.

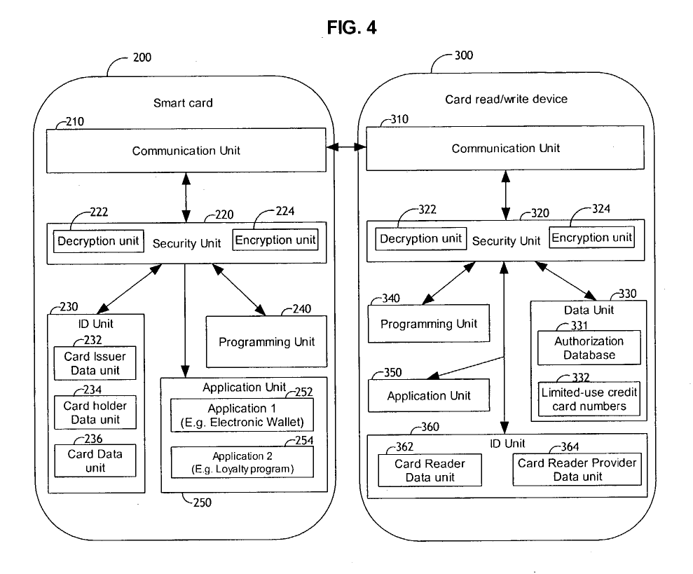

FIG. 4 is a schematic diagram that illustrates one embodiment of a system according to one embodiment of the present invention that comprises a data storage media read/write device and a data storage media. In the embodiment that is illustrated a smart card and a smart card reader is used to illustrate the system. Each element of the smart card and of the reader is further described in the following:

Data Storage Media

A data storage media according to one embodiment of the present invention comprises:

A smart card 200 further comprising:

A. An optional communication unit 210;

B. A optional security unit 220 that comprises a decryption unit 222 and encryption unit 224;

C. An optional ID unit 230 that comprises a card issuer data unit 232, a card holder data unit 234 and a card data unit 236;

D. An optional programming unit 240;

E. An optional application unit 250 that comprises at least one application 252.

A description of each unit of the smart card is included in the following:

A. The Communication Unit 210

The communication unit of the card 200 comprises means for communicating with the communication unit 310 of the card reader 300. In the preferred embodiment of the invention the communication between the card and the card reader is done by establishing a connection between a contact pad comprised on the surface of the smart card and a contact element comprised on the card reader. Such connection between the contact pad of the card and the contact elements of the card reader is established by inserting the smart card into a card insertion slot comprised in the card reader.

In other embodiments of the invention, other means of communication can be utilized, depending on what type of card is used. A contact-less smart card communicates with the corresponding card reader using wireless means of communication (and the card is not inserted into a card insertion slot, but held closely to the reader), a magnetic stripe card communicates with a corresponding magnetic stripe card reader etc.

In yet another embodiment of the present invention, a smart card is equipped with 2 contact pads, one of which is used to program the card reader, the other used for other purposes.

The prior art describes numerous ways of establishing communication between a card and a card reader, all of which can be used with the present invention.

B. The Security Unit 220

In the preferred embodiment of the present invention the security unit of the smart card 200 is used for encrypting and decrypting sensitive information. When a card is inserted into the card reader—or by other means coupled to the card reader, the security unit 220 can optionally cause the user to be prompted to enter a Personal Identification Number (PIN). In the preferred embodiment of the present invention, the card reader is compliant with the FINREAD specifications, and thus the reader comprises a keypad to allow a user to enter a PIN directly into the card reader, without the use of a computer keyboard.

The security unit then uses the decryption unit 222 to decrypt the encrypted PIN information stored in the card data unit 263, and performs a comparison between the entered PIN and the PIN stored on the card. Only if the 2 PINs match, the payment process is allowed to continue.

In alternate embodiments of the present invention, the PIN is not required and in yet another embodiment of the invention it is conceivable that the card reader is not equipped with a keypad, but for example requires the user to enter a PIN using a computer keyboard.

C. The ID Unit 230

According to the preferred embodiment of the present invention, every card must comprise identification information that is used to determine whether or not a card is authorized for use with a particular card reader. An Answer To Reset command is send to the card, which in turn replies with the cards identification information. The ISO 7816 standard describes one suitable card identification system for use with the present invention. Other card identification systems could also be used with the present invention.

Certain data comprised in the ID unit 230 of the smart card 200 can optionally be required to meet certain criteria stored in an optional data unit 340 of the card reader for successful operation to take place. Which specific criteria that must be met in order for a particular card to be authorized for use with a particular card reader, is determined by the card reader provider and/or the card issuer.

C.1. The Card Issuer Data Unit 232

In the preferred embodiment of the present invention, the ID unit comprises a card issuer data unit, which comprises data used to identify the card issuer. The Card Issuer (CI) data unit comprises at least one of the following fields:

CI ID number

CI name

CI street 1

CI street 2

CI city

CI zip

CI state

CI country

CI corporate phone number

CI corporate fax number

CI corporate website

CI corporate email address

CI support phone number

CI support fax number

CI support website

CI support email address

CI promotional website

The data in the Card Issuer data unit can be stored in either un-encrypted or encrypted form. In another embodiment of the present invention, the Card Issuer data unit comprises additional—or other fields, and in yet another embodiment the need for the ID Unit of a smart card to comprise a Card Issuer data unit can conceivably be eliminated.

C.2. The Card Holder Data Unit 234

In the preferred embodiment of the present invention, the Card Holder (CH) data unit comprises at least one of the following fields:

CH ID number

CH company ID number

CH company name

CH name

CH title

CH street 1

CH street 2

CH city

CH zip

CH state

CH country

CH private phone number

CH private fax number

CH private website

CH private email address

CH cell phone number

CH fingerprint image

CH head shape image

CH other biometric information (such as voice pattern or DNA information)

CH birth date

CH social security number

Other useful information

The data in the Card Holder data unit can be stored in either un-encrypted or encrypted format.

In another embodiment of the present invention, the Card Holder data unit comprises additional—or other fields, and in yet another embodiment the need for the ID Unit of a smart card to comprise a Card Holder data unit can conceivably be eliminated.

C.3. The Card Data Unit 236

In the preferred embodiment of the present invention, the Card data unit comprises at least one of the following fields:

Card ID number

Card expiration date

User PIN code (for accessing the card)

Admin PIN code (for programming the card)

User's security level (is he authorized to update the card etc.)

Card's security level (is a PIN needed to access the card, is BOTH a PIN and a fingerprint match needed etc.)

License information (information about limits in the number of uses or other license restrictions)

The data in the Card data unit can be stored in either un-encrypted or encrypted format.

In another embodiment of the present invention, the Card data unit comprises additional—or other fields, and in yet another embodiment the need for the ID Unit of a smart card to comprise a Card data unit can conceivably be eliminated.

D. The Programming Unit 240

The programming unit 240 is used to re-program—or update information comprised the smart card reader. Optionally it is conceivable that the programming unit 240 could also be used when re-programming or updating information on the smart card on which the programming unit is stored—or on a second smart card.

E. The Application Unit 250

In the preferred embodiment of the present invention, at least one of the following applications is provided on the smart card 200 and stored in the application unit 250:

Secure credit

Stored value

Electronic wallet

Insurance (such as proof of insurance and insurance records)

Medical records

Drivers license

Driving record

Electronic Tickets (such as public transit tickets, sports- and cultural events etc.)

Loyalty (such as frequent flyer programs, repeat customer awards, bonus programs etc.)

Electronic coupons (for example for shopping purposes)

Identification

Donor information (such as blood or organs)

PIN and/or password holder

A card issuer and the capacity of the card determine if more than one application is provided on the card. The present invention can be used with any application that can be stored electronically, and not only the few examples mentioned above. Similarly multi-application cards comprising any combination of applications can be used with the device, system and method of the present invention.

Card Reader 300

A data storage media read/write device according to one embodiment of the present invention comprises a card read/write device further comprising:

A. An optional communication unit 310;

B. An optional security unit 320 that comprises an optional encryption unit 324 and an optional decryption unit 322;

C. An optional data unit 330 that comprises an optional authorization database 331 and an optional limited-use credit card number database 332

D. An optional programming unit 340;

E. An optional application unit 350

F. An optional ID 360 unit that comprises an optional card reader data unit 362 and an optional card reader provider data unit 364;

A description of each unit of the card reader is included in the following:

A. The Communication Unit 310

The communication unit 310 of the card reader 300 comprises means for communicating with the communication unit 210 of the card 200. In the preferred embodiment of the invention the communication between the card and the card reader is done through establishing a physical connection between a contact pad comprised on the surface of the smart card and a contact element comprised on the card reader. Such physical connection between the contact pad of the card and the contact elements of the card reader is established by inserting the smart card into a card insertion slot comprised in the card reader.

In other embodiments of the invention, other means of communication can be utilized, depending on what type of card is used, as further described above under the description of the communication unit 210.

B. The Security Unit 320

In the preferred embodiment of the present invention the security unit 320 of the card reader 300 is used for decrypting encrypted data that is received from other sources or stored in other units of the card reader 300. Similarly the security unit is used for encrypting data before remitting it to other sources or before storing it in other units of the card reader.

C. The Data Unit 330

In one embodiment of the present invention, the data unit comprises an optional authorization unit 331 which comprises a non-volatile memory (such as a database) wherein data is stored that is used to match data received from other sources such as an ID unit 230 of a smart card 200.

The files and the fields of the authorization unit of one embodiment of the present invention could be:

Database File: Card Types

Card type ID

Card type name

Card issuer ID

Is card type allowed (yes/no)

Expiration date for card type

Card type license ID

Database File: Card Issuers

Card issuer ID

Card issuer name

Is card issuer allowed (yes/no)

Expiration date for card issuer

Card issuer license ID

Database File: Card Holders

Card Holder ID

Card Holder name

License ID

Database File: Card Holder Preferred Payment Method

Card Holder ID

Preferred Payment method

Database File: Card Holder Payment Options

Payment Option ID

Payment Option Description

Options (examples):

1. Credit card

2. Stored value card

3. Check

b 4. Credit an account

b 5. Money transfer

6. Online payment (such as Pay Pal etc.)

7. Credit phone bill

8. Credit other regular bill (such as Electrical bills, DirecTV, AOL, Magazine subscriptions, Internet subscriptions (such as those proposed according to Microsofts proposed Net strategy) or Internet access)

9. Credit cell phone bill

10. Credit pre-paid cell phone card

11. Credit prepaid phone card

12. Cash (at participating merchants or banks)

Database File: Card Holder Credit Cards

Card Holder ID

Credit card type ID

Expiration date

Credit card number

Database File: Card Holder Account information

Card Holder ID

Account type

Financial institution ID

Account number

Database File: Card Holder Billing information

Card Holder ID

Bill type

Bill issuer

Database File: Financial Institutions

Financial institution ID

Financial institution name

Financial institution SWIFT code

Other information about the institution (such as address, website etc.)

Database File: License Information

License ID

Apply to card types

Apply to card issuers

Number of allowed uses

Number of uses left

Allowed period begin

Allowed period end

The data unit 330 of the one embodiment of the card reader 300 further comprises a limited-use credit card number database 332. When a stored value is deducted from a card, a use can be granted access to one of a plurality of pre-loaded limited-use credit card numbers that can be stored in the data unit 330. The transaction information that is send to the bank along with the stored value that is deducted from the card contains information about which limited-use credit card number will be released for this transaction. Upon receiving the stored value, the banks authorizes the use of the limited-use credit card number for an agreed amount (such as the stored value that was transferred less a transaction fee). The limited-use credit card number can optionally be released upon the reader receiving a confirmation code from the bank.

The limited-use credit card numbers can equally be stored on a storage media such as a smart card to be released when a payment is made.

D. The Programming Unit 340

According to one embodiment of the present invention the programming unit 340 comprises a database that controls by whom and how the card reader can be programmed and/or updated with new data. Some example files and fields of such a database is given in the following:

Database File: Admin Security Level

Are user allowed to change security settings (yes/no)

Admin Security level ID

Database File: Possible Admin Security levels

Admin Security level ID

Admin Privilege Code

Database File: Admin Privilege Codes

Admin Privilege Code

Privilege Description

Options (examples):

1. No restrictions

2. Must provide PIN (or other input key)

3. Must provide PIN OR Biometric authentication

4. Must provide PIN AND Biometric authentication

5. Must provide Biometric authentication

6. Must have physical card with specific card ID present

7. Must have specific card ID present AND provide PIN

8. Must have specific card ID present AND provide PIN AND biometric authentication

Database File: Allowed Admin ID Numbers

Admin ID number

Database file: Admin ID

Admin ID number

Admin name

Admin PIN code

Registered Admin Card ID

Biometric info (such as unique identification information using fingerprint, head shape, DNA, Iris or Voice etc.)

E. The Application Unit 350

In one embodiment of the present invention the card reader 300 comprises an application unit 350 to handle the payment process of the present invention. The application unit can optionally comprise a plurality of different applications.

F. The ID Unit 360

In one embodiment of the present invention the card reader 300 comprises an optional ID unit 360 which comprises an optional card reader data unit 362 and an optional card reader provider data unit 364.

E. 1. Card reader data unit 362

The card reader data unit could comprise at least one of the following fields:

Card reader ID number

Card reader provider ID

Card reader manufacture code

Card reader manufacture date

Card reader Serial number

Card reader Model Identification

E. 2. Card Reader Provider Data Unit 2520

The card reader provider data unit could comprise at least one of the following fields:

Card reader provider ID

Card reader provider name

Other embodiments of the present invention require less memory space in the card and the reader, by reducing the number of files and/or fields in the various databases.

Other embodiments of the present invention does not require the use of databases, but stores authorization information and limited-use credit card numbers in the code of the programming unit 340 of the card reader 300, in the programming unit 240 of the card 200 or in other locations.

A simplified example of a code module (in pseudo code) used to control the release of limited-use credit card numbers to the user is illustrated in the following:

1. Private Sub GetLimitedUseCreditCardNumber()

2. ′REM This code is run when a confirmation code (ConfCode) is received from the bank

3. ′REM The card in this example contains 3 limited-use credit card numbers

4. ′REM ConfCode for this example is an integer between 1 and 3.

5. ′REM The bank keeps track of which numbers have already been used.

6.

7. UseNumber=ConfCode

8.

9. CCNumber=Array(4635504941073001,4635504941073002,4635504941073003)

10.

11. MsgBox “Your limited use credit card number is:” & CCNumber(UseNumber)

12.

13. End Sub

When all limited-use credit card numbers have been used, the bank can optionally offer to provide the user with a new set of limited-use credit card numbers.

The limited-use credit card number can optionally be provided by the bank each time a transaction is requested or the bank can provide means for generating said limited use credit card numbers at the user's end as described above and in the prior art.

A simplified example of a code module (in pseudo code) used to control which card are authorized for use with the device of the present invention is illustrated in the following:

0. Private Sub CheckCard ()

1. X=3

2. AuthorizedCardIssuerID=Array(“American Express” “Visa”, “Mastercard”)

3. LicenseExpirationDates=Array(010102, 010102, 010102)

4.

5. NumberOfAuthorizedCards=X

6. AccessGranted=False

7.

8. For CycleCount=1 to X

9. If UserCard.CardissuerID=AuthorizedCardlssuerID(CycleCount) and_{—}

10. UserCard.CardExpirationDate >=LicenseExpirationDates(CycleCount) then

11. AccessGranted=true

12. Exit For

13. End if

14. Next CycleCount

15. End Sub

If for example a new card issuer must be added to the list of authorized card issuers, the programming unit would only need to correct the value of X in line 1., append the new AuthorizedCardissuerID to the string in line 2., and append the corresponding LicenseExpirationDate (if any) in line 3.

### CONCLUSIONS, RAMIFACTIONS AND SCOPE

Conclusion

It will be apparent to the reader that the payment system and the device of the invention provides a highly secure payment process that drastically reduces the risk of credit card fraud. Furthermore the invention facilitates the use of electronic storage media such as smart cards as payment devices over networks such as the Internet, by providing a solution that does not require payees to invest in additional infrastructure or add additional services to enable user's to make secure stored value payments over a network.

Ramifications

Although the preferred embodiment of the present invention comprises an electronic data storage media read/write device in the form of a smart card reader, any other device which comprises means for reading data from and/or writing data to electronic storage media can be used with the present invention. A few examples of such devices are mentioned below:

TV set top boxes

Personal Digital Assistants (PDA's)

Cell phones

Payment terminals

Point Of Sale terminals (POS)

ATM's

Although the preferred embodiment of the present invention uses an electronic data storage media in the form of a smart card to transfer funds to a bank prior to receiving a limited-use credit card number, any other payment means can be used with the present invention to satisfy the conditions that is required for the bank to provide a limited-use credit card number. A few examples of such payment methods are mentioned below:

The transaction amount can be debited or credited a user's account with a financial institution The transaction amount can be billed separately to the user or included on existing bills (telephone bills, utilities bills, cable—or satellite TV bills, Internet access bills etc.) The transaction amount can be deducted from a prepaid phone card The transaction amount can paid for by providing a cell phone number—and adding the amount to the monthly bill or deducting the amount from a prepaid cell phone account or card.

Not only smart cards, but any electronic data storage media can be used with the present invention, as previously described in this application under the “Terminology” section.

Scope

Various changes to the foregoing described and shown methods and devices and corresponding structures would now be evident to those skilled in the art. It is to be understood, however, that even though numerous characteristics and advantages of the present invention have been set forth in the foregoing description, together with details of the structure and function of some embodiments of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A method for making electronic transactions comprising the steps of:
deducting stored value from a data storage media;
providing a limited-use credit card number

2. A method according to claim 1 further comprising:
transferring said deducted stored value over a network to a service provider

3. A method according to claim 1 wherein said transaction is conducted over a network.

4. A method according to claim 3 wherein said network is selected from a group comprising:
Internet;
Cable TV networks;
Satellite networks;
Telephone networks;
Cell phone networks;
Wireless networks;
AOL;
Compuserve;
Corporate intranets;
Other proprietary networks;
Other public networks;

5. A method according to claim 3 wherein said data storage media is selected from a group comprising:
Bar code card;
CD-ROM;
Citizen card;
Compact Disc;
Compact Flash card;
Contact smart card;
Contact-less smart card;
DVD;
Floppy disks;
Hard disks;
IC cards;
Loyalty program card;
Magnetic stripe card;
Memory chip;
Memory module;
Memory stick;
Mini disk;
Payment card;
PC cards;
Phone card;
RAM module;
SIM card;
Micro SIM card;
Smart Media card;
Stored value card;
Tapes;
Zip disks;
Access cards;
Election cards;
Electronic books;
Identification cards;
USB dongle
Token devices
Cell phones

6. A method according to claim 1 wherein said data storage media is selected from a group comprising:
Bar code card;
CD-ROM;
Citizen card;
Compact Disc;
Compact Flash card;
Contact smart card;
Contact-less smart card;
DVD;
Floppy disks;
Hard disks;
IC cards;
Loyalty program card;
Magnetic stripe card;
Memory chip;
Memory module;
Memory stick;
Mini disk;
Payment card;
PC cards;
Phone card;
RAM module;
SIM card;
Micro SIM card;
Smart Media card;
Stored value card;
Tapes;
Zip disks;
Access cards;
Election cards;
Electronic books;
Identification cards;
USB dongle
Token devices
Cell phones

7. A method according to claim 1 wherein said limited-use credit card number is provided by means selected from a group comprising:
transferring said limited-use credit card number over a communication network;
providing means for generating said limited-use credit card number at the user end;
releasing a limited-use credit card number that is stored in a data storage media;
releasing a limited-use credit card number that is stored in a data storage media read/write device;

8. A device for making stored value transactions which comprises:
means for writing/reading information to/from data storage media;
means for deducting a stored value from a data storage media;
means for receiving a limited-use credit card number;
means for providing said limited-use credit card number to a third party;

9. A device according to claim 8 further comprising
means for transferring said deducted stored value to a payee;

10. A device according to claim 8 wherein said data storage media is selected from a group comprising:
Bar code card;
CD-ROM;
Citizen card;
Compact Disc;
Compact Flash card;
Contact smart card;
Contact-less smart card;
DVD;
Floppy disks;
Hard disks;
IC cards;
Loyalty program card;
Magnetic stripe card;
Memory chip;
Memory module;
Memory stick;
Mini disk;
Payment card;
PC cards;
Phone card;
RAM module;
SIM card;
Micro SIM card;
Smart Media card;
Stored value card;
Tapes;
Zip disks;
Access cards;
Election cards;
Electronic books;
Identification cards;
USB dongle
Token devices
Cell phones
